(19) United States
(12) Patent Application Publication
(10) Pub. No.: US 2024/0232382 A1
(43) Pub. Date: Jul. 11, 2024

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Kota HIROSE, Tokyo (JP)

(73) Assignee: NEC Corporation, Tokyo (JP)

(21) Appl. No.: 18/392,382

(22) Filed: Dec. 21, 2023

(30) Foreign Application Priority Data
Jan. 5, 2023 (JP) 2023-000689

(51) Int. Cl. G06F 21/57; G06F 8/10; G06F 8/41; G06F 8/71

(52) U.S. Cl. CPC G06F 21/577; G06F 8/10; G06F 8/433; G06F 8/71

(57) ABSTRACT

An information processing apparatus including: a library information extraction unit that extracts library information from design specification information; a dependency relation information generation unit that generates dependency relation information based on the library information and a source code; a vulnerability program determination unit that determines whether or not the library information includes a vulnerability program; a dependency relation determination unit that, if the library information includes the vulnerability program and a version upgrade of the vulnerability program is necessary, determining whether or not there is a dependency relation between a library corresponding to the vulnerability program and another library; and an output information generation unit that, if it is determined that there is no dependency relation between the library and another library, generating output information indicating that it is possible to perform a version upgrade of the library corresponding to the vulnerability program.

### CROSS-REFERENCE TO RELATED APPLICATION

This application is based upon and claims the benefit of priority from Japanese patent application No. 2023-000689, filed on Jan. 5, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium for managing vulnerabilities.

### 2. Background Art

When a vulnerability is found in a program, vulnerability information regarding the target program (information that includes the content of the found vulnerability and measures for avoiding the threat of the vulnerability (for example, applying a patch)) is notified to the user.

However, even when the vulnerability information is notified, it is not possible to take prompt measures with respect to the target program when the system is operating. In view of this, there is desire to investigate the influence that vulnerabilities have on the system and notify the user of the investigation result at an early stage.

As a related technology, Patent Document 1 (Japanese Patent Laid-Open Publication No. 2020-021309) discloses a vulnerability management system that investigates the influence on actual products from vulnerabilities in software (program) that is implemented in a plurality of different products, and notifies concerned individuals of the result of the investigation. According to the vulnerability management system in Patent Document 1, a target product for which the influence of vulnerabilities needs to be investigated is extracted based on predetermined configuration information regarding the target product, and predetermined vulnerability information that has been found or made available to the public. In addition, with the vulnerability management system in Patent Document 1, the influence of the vulnerabilities of software implemented in the extracted target product is investigated, and report information indicating the result of the investigation of the influence is generated and transmitted to a predetermined destination at a predetermined timing.

In the vulnerability management system disclosed in Patent Document 1, a report indicating the result of the investigation of the influence is presented to a PSIRT (Product Security Incident Response Team). However, the report disclosed in Patent Document 1 only prompts the necessity to handle the vulnerabilities, and does not present a method for handling the vulnerabilities to a system administrator or operator.

### SUMMARY OF THE INVENTION

An example object of the present disclosure is to present a method for handling vulnerabilities.

In order to achieve the example object described above, an information processing apparatus according to an example aspect includes:
a library information extraction unit that extracts library information indicating one or more libraries included in design specification information indicating a design specification of a program that is used in a target system;
a dependency relation information generation unit that generates dependency relation information indicating a dependency relation between the libraries, based on the library information and a source code of the program;
a vulnerability program determination unit that determines whether or not the library information includes a vulnerability program indicating a program that has a vulnerability;
a dependency relation determination unit that, if the library information includes the vulnerability program and a version upgrade of the vulnerability program is necessary, determining whether or not there is a dependency relation between a library corresponding to the vulnerability program and another library, based on the dependency relation information; and
an output information generation unit that, if it is determined that there is no dependency relation between the library corresponding to the vulnerability program and another library, generating output information indicating that it is possible to perform a version upgrade of the library corresponding to the vulnerability program, with respect to a version of the program.

Also, in order to achieve the example object described above, an information processing method according to an example aspect includes a instructions that cause an information processing apparatus to carry out:
extracting library information indicating one or more libraries included in design specification information indicating a design specification of a program that is used in a target system;
generating dependency relation information indicating a dependency relation between the libraries, based on the library information and a source code of the program;
determining whether or not the library information includes a vulnerability program indicating a program that has a vulnerability;
if the library information includes the vulnerability program and a version upgrade of the vulnerability program is necessary, determining whether or not there is a dependency relation between a library corresponding to the vulnerability program and another library, based on the dependency relation information; and
if it is determined that there is no dependency relation between the library corresponding to the vulnerability program and another library, generating output information indicating that it is possible to perform a version upgrade of the library corresponding to the vulnerability program, with respect to a version of the program.

Furthermore, in order to achieve the example object described above, a computer-readable recording medium according to an example aspect includes a program recorded on the computer-readable recording medium, the program including instructions that cause the computer to carry out:
extracting library information indicating one or more libraries included in design specification information indicating a design specification of a program that is used in a target system;
generating dependency relation information indicating a dependency relation between the libraries, based on the library information and a source code of the program;
determining whether or not the library information includes a vulnerability program indicating a program that has a vulnerability;
if the library information includes the vulnerability program and a version upgrade of the vulnerability program is necessary, determining whether or not there is a dependency relation between a library corresponding to the vulnerability program and another library, based on the dependency relation information; and
if it is determined that there is no dependency relation between the library corresponding to the vulnerability program and another library, generating output information indicating that it is possible to perform a version upgrade of the library corresponding to the vulnerability program, with respect to a version of the program.

According to the present disclosure as described above, a method for handling a vulnerability can be presented.

### BRIEF DESCRIPTION OF THE DRAWINGS

FIG. 1 is a diagram showing an example of a system that includes the information processing apparatus.

FIG. 2 is a diagram for describing an example of the data structure of the extraction result information.

FIG. 3 is a diagram for describing an example of the data structure of the dependency relation information.

FIG. 4 is a diagram for describing an example of the rule information.

FIG. 5 is a diagram for describing an example of the rule reflection state information.

FIG. 6 is a diagram for describing an example of the data structure of the vulnerability information.

FIG. 7 is a diagram for describing an example of the data structure of the determination result information.

FIG. 8 is a diagram for describing operation examples of the information processing apparatus (the extraction unit and the generation unit).

FIG. 9 is a diagram for describing operation examples of steps A1 and A2.

FIG. 10 is a diagram for describing an operation example of step A3.

FIG. 11 is a diagram for describing an operation example of step A4.

FIG. 12 is a diagram for describing an operation example of step A5.

FIG. 13 is a diagram for describing operation examples of the information processing apparatus (the determination unit, the infrastructure construction information regeneration unit, and the output information generation unit).

FIG. 14 is a diagram for describing operation examples of steps F1 and F2.

FIG. 15 is a diagram for describing operation examples of steps F3 and F4.

FIG. 16 is a diagram for describing operation examples in steps F5 and F6.

FIG. 17 is a diagram for showing an example of a computer that realizes the information processing apparatus.

### EXEMPLARY EMBODIMENT

Hereinafter, an example embodiment will be described with reference to the drawings. Note that, in the drawings described below, elements having the same functions or corresponding functions are denoted by the same reference numerals, and repeated description thereof may be omitted.

### Example Embodiment

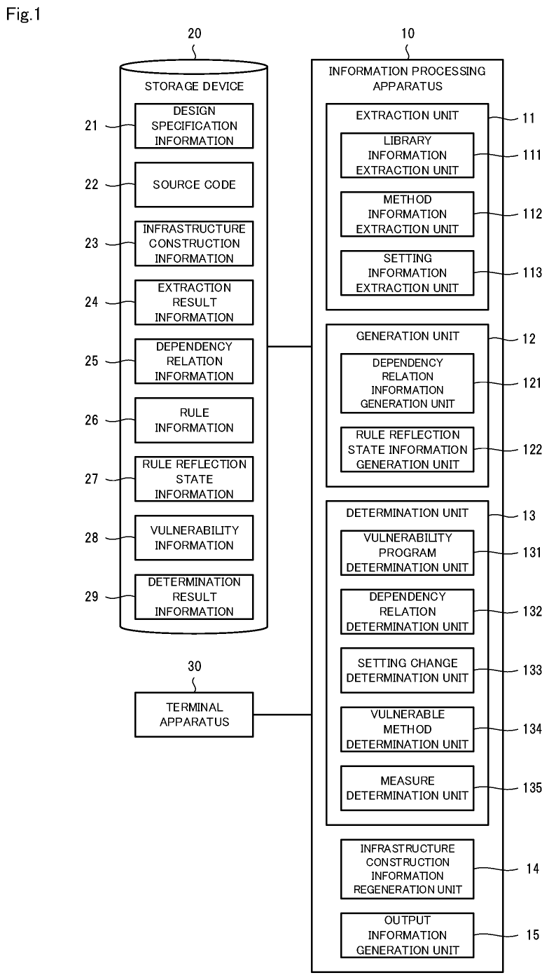

A configuration of an information processing apparatus according to an example embodiment will be described with reference to FIG. 1. FIG. 1 is a diagram showing an example of a system that includes the information processing apparatus.

### System Configuration

As shown in FIG. 1, a system 100 according to the example embodiment includes an information processing apparatus 10, a storage device 20, and a terminal apparatus 30. In addition, the information processing apparatus 10, the storage device 20, and the terminal apparatus 30 are electrically connected via a network.

The network is an ordinary communication network constructed using a communication line such as the Internet, a LAN (Local Area Network), a dedicated line, a phone line, an intranet, a mobile communication network, Bluetooth (registered trademark), or Wi-Fi (Wireless Fidelity) (registered trademark).

The information processing apparatus 10 is an information processing apparatus such as a CPU (Central Processing Unit), a programmable device such as an FPGA (Field-Programmable Gate Array), a GPU (Graphics Processing Unit), or a circuit, server computer, personal computer or mobile terminal in which one or more thereof are mounted.

The information processing apparatus 10 is an apparatus that presents a method for handling vulnerabilities. In addition, as shown in FIG. 1, the information processing apparatus 10 includes an extraction unit 11 (a library information extraction unit 111, a method information extraction unit 112, and a setting information extraction unit 113), a generation unit 12 (a dependency relation information generation unit 121 and a rule reflection state information generation unit 122), a determination unit 13 (a vulnerability program determination unit 131, a dependency relation determination unit 132, a setting change determination unit 133, a vulnerable method determination unit 134, and a measure determination unit 135), an infrastructure construction information regeneration unit 14, and an output information generation unit 15.

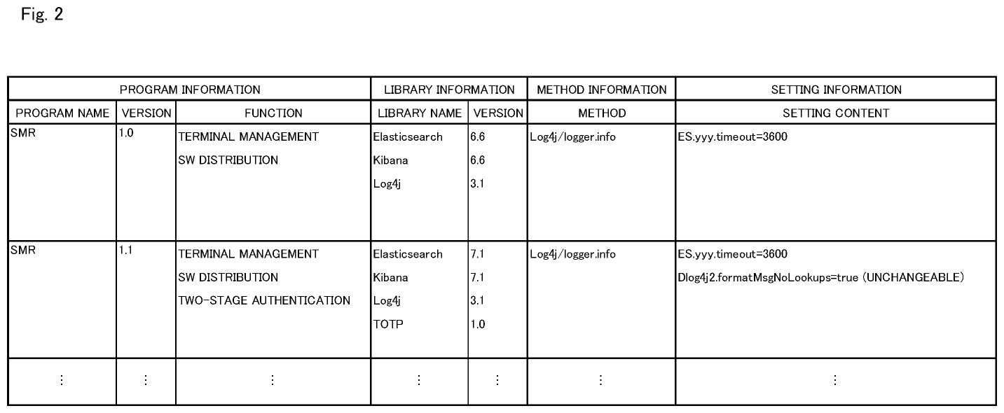

The storage device 20 is a database, a server computer, a circuit that includes a memory, or the like. The storage device 20 stores various types of information, for example. In addition, in the example in FIG. 2, the storage device 20 is provided outside the information processing apparatus 10, but may be provided inside the information processing apparatus 10. Furthermore, the storage device 20 may use a plurality of storage devices, and may separately store various types of information.

The terminal apparatus 30 is an information processing apparatus such as a CPU, a programmable device such as an FPGA, a GPU, or a circuit, a personal computer, or a mobile terminal in which one or more thereof are mounted.

The terminal apparatus 30 is electrically connected to input devices and an output device. The input devices are devices such as a touch panel, a mouse, and a keyboard. The output device obtains output information subjected to conversion into a format that can be output, and outputs a generated image, sound, and the like based on the output information. The output device is an image display device or the like that uses a liquid crystal display, an organic EL (Electro Luminescence) display, or a CRT (Cathode Ray Tube), for example. Furthermore, the image display apparatus may include a sound output device such as a speaker. Note that the output device may be a printing device such as a printer.

The extraction unit of the information processing apparatus will be described in detail.

The extraction unit 11 includes the library information extraction unit 111, the method information extraction unit 112, and the setting information extraction unit 113. First, the extraction unit 11 extracts later-described library information, method information, and setting information, with respect to a program that is used in a target system. Next, the extraction unit 11 generates extraction result information 24 using the extracted library information, method information, and setting information.

Extraction of library information, method information, and setting information will be described.

The library information extraction unit 111 extracts library information indicating one or more libraries included in design specification information 21 indicating the design specification of the program that is used in the target system.

The program is software implemented in hardware of the target system in order to provide a product or a service. The design specification information 21 is text data indicating the design specification of the program, for example. Note that, in the example in FIG. 1, the design specification information 21 is stored in the storage device 20, but may be stored in a storage device that is managed by a development department of the product or the service. Note that the storage destination of the design specification information 21 is not limited to the storage device of the development department.

Specifically, first, the library information extraction unit 111 obtains the design specification information 21 stored in the storage device 20. Next, the library information extraction unit 111 extracts library information from the design specification information 21 (library extracting processing). Next, the library information extraction unit 111 stores program information indicating the program that is used in the target system and the extracted library information in association with each other to the storage device 20.

The library extracting processing is processing for extracting library information from the design specification information 21 (text data) using term data for searching for a library, the term data being related to libraries set in advance, for example.

Alternatively, the library extracting processing may be processing for extracting library information by inputting the design specification information 21 to a model for extracting libraries, the model having been subjected to machine learning.

Note that the library extracting processing is not limited to that described above, and it suffices for the processing to be able to extract libraries.

The program information is information in which program name information indicating the name of each program and program version information indicating the version of the program are associated with each other. Note that the name of the program is information indicating a product name, a service name, or the like. Furthermore, the program information may include program function information indicating a function that the program has (function provided by a product or a service).

The library information is information in which library name information indicating the name of each library and library version information indicating the version of the library are associated with each other.

The method information extraction unit 112 extracts method information indicating one or more methods included in a source code 22 of the program. The method information is information indicating one or more methods that are used in the source code, for example.

Note that, in the example in FIG. 1, the source code 22 is stored in the storage device 20, but may be stored in a storage device managed by a development department of a product or a service. Note that the storage destination of the source code 22 is not limited to the storage device of the development department.

Specifically, first, the method information extraction unit 112 obtains the source code 22 stored in the storage device 20. Next, the method information extraction unit 112 extracts method information from the source code 22 (method extracting processing). Next, the method information extraction unit 112 stores, to the storage device 20, the program information indicating the program that is used in the target system and the extracted method information in association with each other.

The method extracting processing is processing for extracting method information from the source code 22 (text data), for example, using a method description format for each language and pattern matching, for example, for searching for a method.

Alternatively, the method extracting processing may be processing for extracting method information by inputting the source code 22 to a model for extracting a method, the model having been subjected to machine learning.

Note that the method extracting processing is not limited to that described above, and it suffices for the processing to be able to extract a method.

The setting information extraction unit 113 extracts setting information indicating one or more setting contents that are used in an infrastructure that is indicated by infrastructure construction information 23 and is for constructing the system.

The infrastructure construction information 23 is information such as IaC (Infrastructure as Code) for managing an infrastructure as a code, and setting information that is used for a program, for example. The setting information is information indicating setting contents that are set for an infrastructure written in the IaC, for example.

Note that, in the example in FIG. 1, the infrastructure construction information 23 is stored in the storage device 20, but may be stored in a storage device managed by an operating department of a product or a service. Note that the storage destination of the infrastructure construction information 23 is not limited to the storage device of the operating department.

Specifically, first, the setting information extraction unit 113 obtains the infrastructure construction information 23 stored in the storage device 20. Next, the setting information extraction unit 113 extracts setting information from the infrastructure construction information 23 (setting information extracting processing).

The setting information extracting processing is processing for extracting setting information from the infrastructure construction information 23 (text data such as IaC), for example, using a description format for setting information for each system and pattern matching. for example, for searching for setting information.

Alternatively, the setting information extracting processing may be processing for extracting setting information by inputting the infrastructure construction information 23 to a model for extracting settings, the model having been subjected to machine learning.

Note that the setting information extracting processing is not limited to that described above, and it suffices for the processing to be able to extract setting information.

Next, the setting information extraction unit 113 retrieves the setting information extracted from the design specification information 21, and determines whether or not the extracted setting information is changeable. Note that, for the determination as to whether or not the extracted setting information is changeable, for example, a model for determining whether or not the extracted setting information is changeable, the model having been subjected to machine learning, is used.

Next, the setting information extraction unit 113 stores, to the storage device 20, the program information indicating the program that is used in the target system, the extracted setting information, and setting changeable/unchangeable information indicating whether or not the extracted setting information is changeable, in association with each other.

Extraction result information will be described.

The extraction unit 11 generates the extraction result information 24, and stores the generated extraction result information 24 to the storage device 20. The extraction result information 24 is information in which the program information of the target program, and the extracted library information, method information, and setting information are associated with one another.

FIG. 2 is a diagram for describing an example of the data structure of the extraction result information. In the example in FIG. 2, in the extraction result information, the program information (program name information “program name”, program version information “version”, and program function information “function”), the library information (library name information “library name” and library version information “version”), the method information (“method”), and the setting information (“setting content”) are associated with one another.

In the example in FIG. 2, a program named “SMR” is stored under “program name”. In addition, “1.0” and “1.1” indicating versions of “SMR” are stored under “version”. In addition, functions that versions “1.0” and “1.1” of the program “SMR” have are stored under “function”. “Terminal management” indicating a function of managing terminal apparatuses and “SW distribution” indicating a function of distributing software to terminal apparatuses are stored under “function” corresponding to “1.0” of “SMR”. “Two-stage authentication” indicating two-stage authentication is stored under “function” corresponding to “1.1” of “SMR” in addition to “terminal management” and “SW distribution”.

Libraries named “Elasticsearch”, “Kibana”, and “Log4j” are stored under “library name” corresponding to “1.0” of “SMR”. In addition, “6.6”, “6.6”, and “3.1” indicating the versions of the libraries are stored under “version” corresponding to “Elasticsearch”, “Kibana”, and “Log4j”, respectively.

The libraries named “Elasticsearch”, “Kibana”, “Log4j”, and “TOTP” are stored under “library name” corresponding to “1.1” of “SMR”. In addition, “7.1”, “7.1”, “3.1”, and “1.0” indicating the versions of the libraries are stored under “version” corresponding to “Elasticsearch”, “Kibana”, “Log4j”, and “TOTP”, respectively.

“Log4j/logger.info” is stored under “method” corresponding to “1.0” and “1.1” of “SMR”. “ES.yyy.timeout=3600” is stored under “setting content” corresponding to “1.0” of “SMR”. “ES.yyy.timeout=3600” and “Dlog4j2.formatMsgNoLookups=true (unchangeable)” are stored under “setting content” corresponding to “1.1” of “SMR”.

Note that the above-described extraction result information shown in FIG. 2 is exemplary, and there is no limitation to the extraction result information shown in FIG. 2.

Note that “(unchangeable)” mentioned above is setting changeable/unchangeable information, and indicates that the setting information is not changeable (unchangeable). That is to say, the setting changeable/unchangeable information (unchangeable) represents a set value that is unchangeable as a specification of the system, in the setting information extracted from the infrastructure construction information. In contrast, “(unchangeable)” not being included indicates that the setting information can be changed (changeable).

The generation unit of the information processing apparatus will be described in detail.

The generation unit 12 includes the dependency relation information generation unit 121 and the rule reflection state information generation unit 122. The generation unit 12 first generates dependency relation information 25 and rule reflection state information 27, with respect to a program that is used in a target system. Note that the extraction result information 24 may include the dependency relation information 25 and the rule reflection state information 27.

The dependency relation information generation unit 121 generates the dependency relation information 25 indicating the dependency relation between libraries based on the library information and the source code 22.

Specifically, first, the dependency relation information generation unit 121 obtains the library information and the source code 22 stored in the storage device 20. Next, the dependency relation information generation unit 121 detects libraries that have a dependency relation, using the library information and the source code 22 (library dependency relation detection processing). Next, the dependency relation information generation unit 121 generates the dependency relation information 25 indicating the dependency relation between the libraries. Next, the dependency relation information generation unit 121 stores the program information and the dependency relation information in association with each other to the storage device 20.

The library dependency relation detection processing is processing for detecting whether or not an extracted library references another library, in the source code 22 using the library information extracted by the library information extraction unit 111, for example. In processing for detecting whether or not an extracted library references another library, detection is performed using pattern matching based on a description format of call declaration of the library, for example.

Note that the library dependency relation detection processing is not limited to that described above, and it suffices for the processing to be able to detect the dependency relation between libraries.

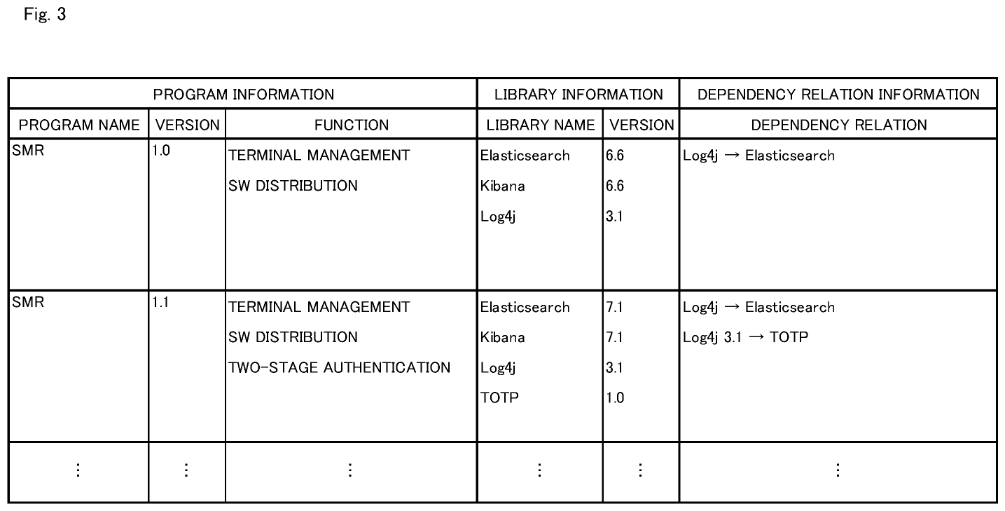

FIG. 3 is a diagram for describing an example of the data structure of the dependency relation information. In the example in FIG. 3, the dependency relation information (“dependency relation”) is associated with the program information (program name information “program name”, program version information “version”, and program function information “function”), and the library information (library name information “library name” and library version information “version”). In addition, the dependency relation information 25 may be included in the extraction result information 24.

In the example in FIG. 3, under the dependency relation information “dependency relation” indicating the dependency relation between libraries used in “1.0” of “SMR”, “Log4j->Elasticsearch” indicating that the library “Log4j” is related to the library “Elasticsearch” is stored. In addition, under the dependency relation information “dependency relation” indicating the dependency relation between libraries used in “1.1” of “SMR”, “Log4j 3.1->TOTP” indicating that the library “Log4j 3.1” is related to the library “TOTP” is stored, in addition to “Log4j->Elasticsearch”.

Note that the above-described dependency relation information shown in FIG. 3 is exemplary, and there is no limitation to the dependency relation information shown in FIG. 3.

The rule reflection state information generation unit 122 uses rule information 26 indicating the security requirements of the system, to detect reflection states of the security requirements included in the design specification information 21, and generates the rule reflection state information 27 indicating the reflection states of the respective security requirements.

Specifically, first, the rule reflection state information generation unit 122 obtains the design specification information 21 and the rule information 26 stored in the storage device 20. Next, the rule reflection state information generation unit 122 detects the reflection states of the security requirements included in the design specification information 21, using the design specification information 21 and the rule information 26 (rule reflection state detection processing).

Next, the rule reflection state information generation unit 122 generates the rule reflection state information 27 indicating the reflection states of the security requirements. Next, the rule reflection state information generation unit 122 stores the program information and the rule reflection state information 27 in association with each other to the storage device 20.

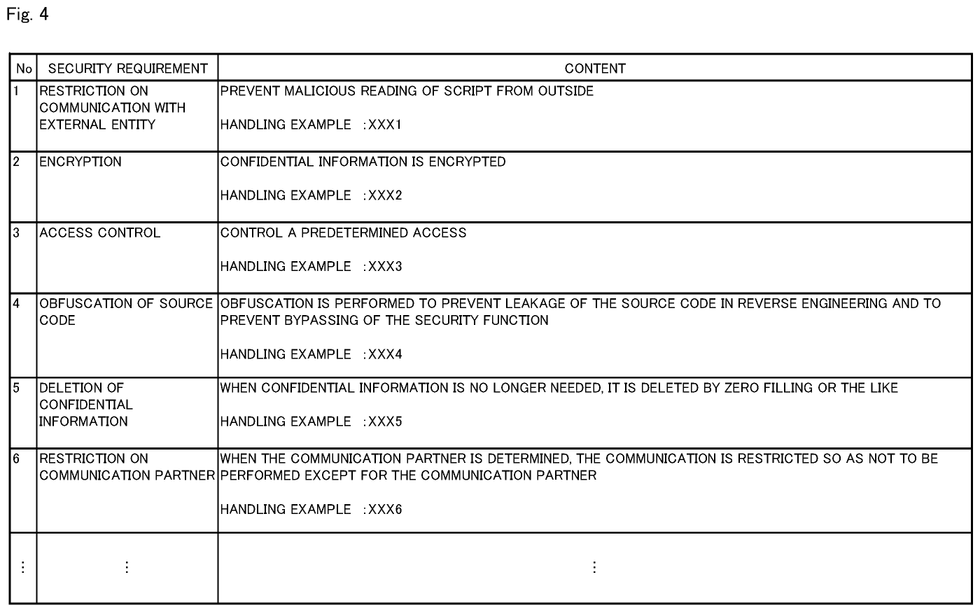

In the rule reflection state detection processing, natural language analysis processing is executed on the content of the rule information 26, and how the security requirements are defined is analyzed, for example. In the case of “2” under “No” in the example in FIG. 4, words such as “confidential information”, “is”, and “encrypted” are extracted. Next, the words in the analysis result of the natural language analysis processing are searched for in the design specification information 21 (text data) using pattern matching or the like. Next, whether or not the security requirements in the design specification information 21 are reflected is detected using a model for detecting a reflection state, the model having been subjected to machine learning using text around search results and results of natural language analysis processing.

Note that the rule reflection state detection processing is not limited to that described above, and it suffices for the processing to be able to detect rule reflection states.

In the rule information 26, a list for checking security requirements and the like are used. That is to say, if the security requirements in the list are satisfied, a certain level of security is secured. Note that, in the example in FIG. 1, the rule information 26 is stored in the storage device 20, but may be stored in a storage device managed by a development department of a product or a service. Note that the storage destination of the rule information 26 is not limited to the storage device of the development department.

FIG. 4 is a diagram for describing an example of the rule information. In the example in FIG. 4, in the rule information, security requirement identification information “No” for identifying each security requirement, security requirement name information “security requirement” indicating the name of the security requirement, and security requirement content information “content” indicating the content of the security requirement are associated with one another. The content may be a handling method, a handling example, and the like.

In the example in FIG. 4, “restriction on communication with external entity”, “encryption”, “access control”, “obfuscation of source code”, “deletion of confidential information”, “restriction on communication partner”, . . . under security requirement name information “security requirement” are respectively associated with “1”, “2”, “3”, “4”, “5”, “6”. . . under the security requirement identification information “No”. In addition, the security requirement content information is associated with the security requirement name information “restriction on communication with external entity”, “encryption”, “access control”, “obfuscation of source code”, “deletion of confidential information”, “restriction on communication partner”, . . . .

In the case of “1”, namely “restriction on communication with external entity”, for example, a handling method “prevent malicious reading of script from outside” and a handling example “handling example: XXX1” are stored as security requirement content information. Note that, similarly, handling methods and handling examples are also stored for “encryption”, “access control”, “obfuscation of source code”, “deletion of confidential information”, “restriction on communication partner”, . . .

Note that the above-described rule information shown in FIG. 4 is exemplary, and there is no limitation to the rule information shown in FIG. 4.

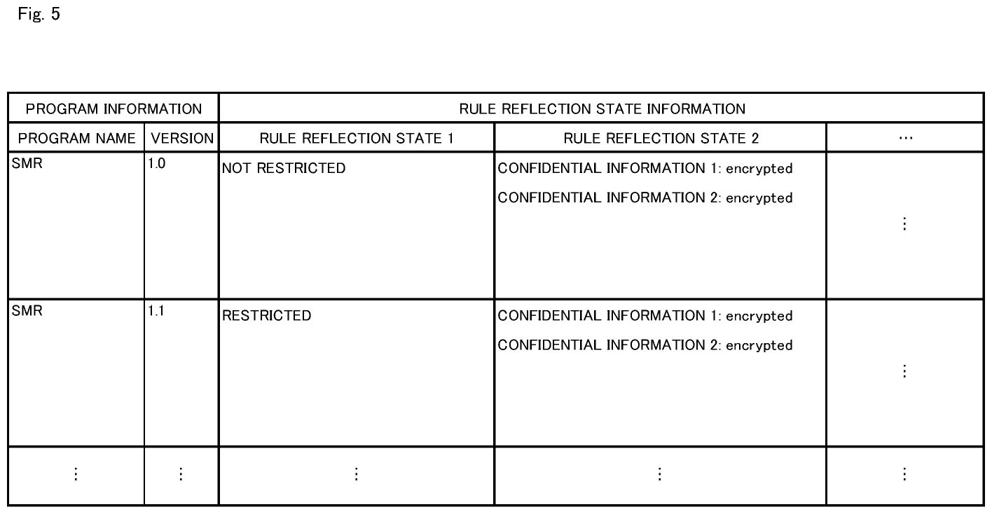

FIG. 5 is a diagram for describing an example of the rule reflection state information. In the example in FIG. 5, the rule reflection state information is associated with the program information (program name information “program name” and program version information “version”). In addition, the rule reflection state information 27 may be stored in association with the extraction result information 24.

In the example in FIG. 5, for each of “1.0” and “1.1” of the program “SMR”, rule reflection state information “rule reflection state 1” indicating a reflection state of a security requirement 1 (restriction on communication with external entity), rule reflection state information “rule reflection state 2” indicating a reflection state of a security requirement 2 (encryption), . . . are stored.

Under the rule reflection state information “rule reflection state 1” of “1.0” of “SMR”, “not restricted” indicating that restriction on communication with an external entity is not reflected on the program is stored. In addition, under the rule reflection state information “rule reflection state 2”, “confidential information 1: encrypted, confidential information 2: encrypted” indicating that encryption of confidential information is reflected on the program is stored. Note that, also as for “1.1” of “SMR”, similarly, whether or not the security requirements are reflected on the program is stored under the rule reflection state information.

Note that the above-described rule reflection state information shown in FIG. 5 is exemplary, and there is no limitation to the rule reflection state information shown in FIG. 5.

The determination unit of the information processing apparatus will be described in detail.

The determination unit 13 includes the vulnerability program determination unit 131, the dependency relation determination unit 132, the setting change determination unit 133, the vulnerable method determination unit 134, and the measure determination unit 135. Regarding a program that is used in a target system, the determination unit 13 first generates determination result information 29 indicating a result of determination as to whether or not a vulnerability needs to be handled.

The vulnerability program determination unit 131 determines whether or not the library information includes a vulnerability program indicating a program that has a vulnerability.

Specifically, first, the vulnerability program determination unit 131 obtains vulnerability program information indicating a program that has a vulnerability, from vulnerability information 28 stored in the storage device 20. Next, the vulnerability program determination unit 131 references the library information using the vulnerability program information, and determines whether or not there is a library that matches the vulnerability program.

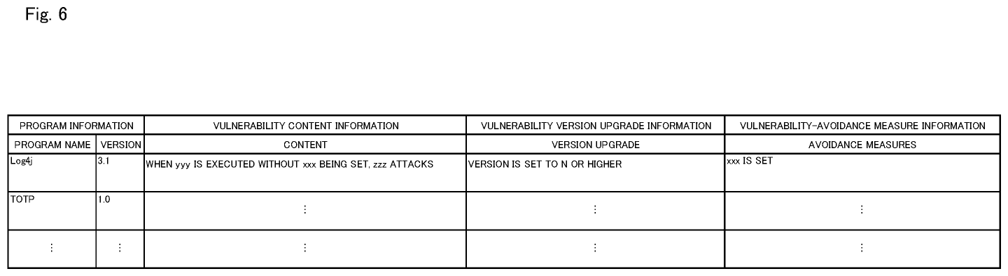

The vulnerability information 28 is a database of information regarding vulnerabilities collected from websites, databases, and the like. FIG. 6 is a diagram for describing an example of the data structure of the vulnerability information.

In the example in FIG. 6, in the vulnerability information, vulnerability program name information “program name” indicating the name of each vulnerability program, vulnerability program version information “version” indicating the version of the vulnerability program, vulnerability content information “content” indicating the content of the vulnerability, vulnerability version upgrade information “version upgrade” indicating a handling method that uses a version upgrade (apply a patch), and vulnerability-avoidance measure information “avoidance measures” indicating vulnerability avoidance measures (change setting) are associated with one another.

In the example in FIG. 6, “when yyy is executed without xxx being set, zzz attacks” is stored under the vulnerability content information “content” of “3.1” of “Log4j”. In addition, “version is set to N or higher” is stored under the vulnerability version upgrade information “version upgrade” of “Log4j” of “3.1”. In addition, “xxx is set” is stored under the vulnerability-avoidance measure information “avoidance measures” of “Log4j” of “3.1”.

Note that the above-described vulnerability information shown in FIG. 6 is exemplary, and there is no limitation to the vulnerability information shown in FIG. 6.

Next, if the library information includes a vulnerability program (a library that has a vulnerability), the vulnerability needs to be handled in the program that is used in the target system, and thus the vulnerability program determination unit 131 determines that measures need to be taken for the program. Next, the vulnerability program determination unit 131 stores the determination result (measure target information) to the storage device 20 in association with the program information.

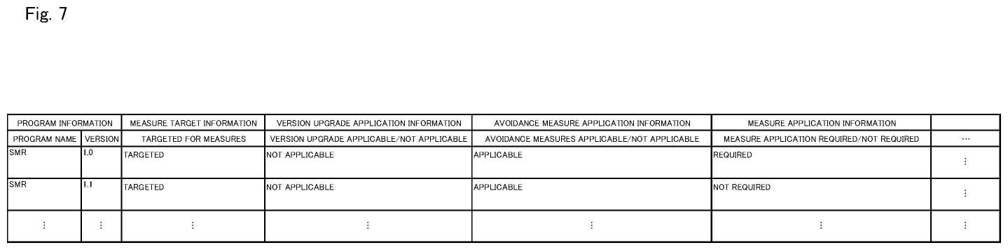

The measure target information is information indicating that the program is targeted for measures or not. The measure target information is associated with the program information (program name information “program name” and program version information “version”). As with the determination result information shown in FIG. 7, for example, “1.0” and “1.1” of the program “SMR” are targeted for measures, and thus measure target information “targeted” is stored under “targeted for measures”.

FIG. 7 is a diagram for describing an example of the data structure of the determination result information. In the example in FIG. 7, the determination result information, the program information (program name information “program name” and program version information “version”), the measure target information “targeted for measures”, version upgrade application information “version upgrade applicable/not applicable”, avoidance measure application information “avoidance measures applicable/not applicable”, and measure application information “measure application required/not required” are associated with one another.

If the library information includes a vulnerability program, and a version upgrade of the vulnerability program is necessary, the dependency relation determination unit 132 determines whether or not there is a dependency relation between the library corresponding to the vulnerability program and another library, based on the dependency relation information.

Specifically, first, the dependency relation determination unit 132 obtains the vulnerability program information of the vulnerability information 28 stored in the storage device 20 and the dependency relation information. Next, when there is a library that matches the vulnerability program, the dependency relation determination unit 132 references the vulnerability version upgrade information corresponding to the vulnerability program, and determines whether or not a version upgrade is necessary.

In the example in FIG. 6, if the vulnerability program is “Log4j”, “set version to N or higher” under the vulnerability version upgrade information “version upgrade” is obtained, and, since the content of the vulnerability version upgrade information is “set version to N or higher”, it is determined that a version upgrade is necessary.

Next, when a version upgrade is necessary, the dependency relation determination unit 132 references the dependency relation information, and determines whether or not there is a dependency relation between the library corresponding to the vulnerability program and another library.

That is to say, if there is a dependency relation between a library that has a vulnerability and another library, a version upgrade of the library that has a vulnerability cannot be performed without careful consideration, and thus it is determined that a version upgrade cannot be performed. In contrast, if there is no dependency relation between a library that has a vulnerability and another library, a version upgrade of the library that has a vulnerability can be performed, and thus it is determined that a version upgrade can be performed.

Next, the dependency relation determination unit 132 stores the determination result (version upgrade application information) to the storage device 20 in association with the program information.

The version upgrade application information is information indicating whether or not a version upgrade of the library that has a vulnerability can be performed (whether or not a patch can be applied). The version upgrade application information is stored in association with the program information (program name information “program name” and program version information “version”). In the case of the determination result information shown in FIG. 7, for example, “1.0” and “1.1” of the program “SMR” include a library that has a vulnerability, and thus version upgrade application information “not applicable” (or “0”, for example) is stored under “version upgrade applicable/not applicable”. Note that, when a version upgrade can be performed, version upgrade application information “applicable” (or “1”, for example) is stored.

The setting change determination unit 133 determines whether or not setting information is changeable, based on the vulnerability-avoidance measure information that indicates a content for avoiding the vulnerability and corresponds to the vulnerability program.

Specifically, first, the setting change determination unit 133 obtains setting information of the extraction result information 24 and vulnerability program information of the vulnerability information 28 stored in the storage device 20. Next, when there is a library that matches the vulnerability program, the setting change determination unit 133 references the vulnerability-avoidance measure information corresponding to the vulnerability program, and obtains avoidance measures.

In the example in FIG. 6, when the vulnerability program is “Log4j”, “xxx is set” under the vulnerability-avoidance measure information “avoidance measures” is obtained.

Next, the setting change determination unit 133 references the setting information of the extraction result information 24 using the setting (set value) of the obtained avoidance measures, and detects setting information “setting content” that matches the setting of the avoidance measures. Next, if setting changeable/unchangeable information indicating that the setting is unchangeable is associated with the detected setting content, the setting change determination unit 133 determines that the setting information cannot be changed to the setting (set value) of the avoidance measures. In contrast, if setting changeable/unchangeable information indicating that the setting is unchangeable is not associated with the detected setting content, it is determined that the setting information can be changed to the setting (set value) of the avoidance measures.

When setting information “Dlog4j2.formatMsgNoLookups=true (unchangeable)” in FIG. 2 is detected, setting changeable/unchangeable information (unchangeable) is associated, and thus it is determined that the setting information cannot be changed to the setting (set value) of the avoidance measures.

Next, the setting change determination unit 133 stores a determination result (avoidance measure application information) in association with the program information to the storage device 20.

The avoidance measure application information is information indicating, when there is a library that has a vulnerability, whether or not the setting information of the infrastructure construction information 23 is changeable (whether or not the avoidance measures can be applied) in order to avoid the vulnerability of the program. The avoidance measure application information is stored in association with the program information (program name information “program name” and program version information “version”). In the case of the determination result information shown in FIG. 7, for example, the setting information of the infrastructure construction information 23 needs to be changed in order to avoid the vulnerabilities of “1.0” and “1.1” of the program “SMR”, and thus avoidance measure application information “applicable” (or “1”, for example) is stored under “avoidance measures applicable/not applicable”. Note that, if the setting information is unchangeable, avoidance measure application information “not applicable” (or “0”, for example) is stored.

The infrastructure construction information regeneration unit 14 changes the setting information of the current infrastructure construction information based on the vulnerability-avoidance measure information and generates new infrastructure construction information, if it is determined that the setting information is changeable.

Specifically, first, if it is determined that setting information is changeable, the infrastructure construction information regeneration unit 14 obtains the current infrastructure construction information stored in the storage device 20. Next, the infrastructure construction information regeneration unit 14 detects setting information from the current infrastructure construction information, changes the detected setting information based on the content of the vulnerability-avoidance measure information, and generates new infrastructure construction information. Next, the infrastructure construction information regeneration unit 14 stores the new infrastructure construction information to the storage device 20.

In the example in FIG. 6, when the vulnerability program is “Log4j”, “xxx is set” is stored under the vulnerability-avoidance measure information “avoidance measures”, and thus the setting information of the current infrastructure construction information is changed based on “xxx is set”, and new infrastructure construction information is generated and stored to the storage device 20.

The vulnerable method determination unit 134 determines whether or not the method information includes a vulnerable method, based on the vulnerability content information that indicates the content of a vulnerability and corresponds to a vulnerability program.

Specifically, first, the vulnerable method determination unit 134 obtains method information of the extraction result information 24 and vulnerability content information of the vulnerability information 28, which are stored in the storage device 20. Next, the vulnerable method determination unit 134 determines whether or not the method information includes a vulnerable method based on the vulnerability content information.

The vulnerability content information and the method information are input to a model for detecting a vulnerable method based on vulnerability content information, the model having been subjected to machine learning, and a vulnerable method is detected, for example. Note that processing for detecting a vulnerable method is not limited to that described above, and it suffices for the processing to be able to detect a vulnerable method.

The measure determination unit 135 determines whether or not a security requirement of rule reflection state information has been applied to the content of a vulnerability indicated by the vulnerability content information.

Specifically, first, if it is determined that the method information includes a vulnerable method, the measure determination unit 135 obtains rule reflection state information of the extraction result information 24 stored in the storage device 20. Next, the measure determination unit 135 determines whether or not the security requirement of the rule reflection state information has been applied to the content of the vulnerability content information.

The vulnerability content information and the rule reflection state information are input to a model for determining whether or not the security requirement of the rule reflection state information has been applied to the content of the vulnerability content information, the model having been subjected to machine learning, and determines whether or not the security requirement has been applied, for example. Note that processing for determining whether or not the security requirement of the rule reflection state information has been applied to the content of the vulnerability content information is not limited to that described above, and thus it suffices for the processing to be able to determine whether or not the security requirement has been applied.

Next, the measure determination unit 135 stores the determination result (measure application information) to the storage device 20 in association with the program information.

The measure application information is information indicating whether or not it is possible to mitigate the influence of an attack (impact) (whether or not the vulnerability needs to be handled) when the vulnerability is abused (when the system is attacked). The measure application information is stored in association with the program information (program name information “program name” and program version information “version”). In the case of the determination result information shown in FIG. 7, for example, the vulnerability needs to be handled in “1.0” of the program “SMR”, and thus measure application information “required” (or “1”, for example) is stored under “measure application required/not required”.

In contrast, for example, in the case of the determination result information shown in FIG. 7, the vulnerability has already been handled in “1.1” of the program “SMR”, and thus measure application information “not required” (or “0”, for example) is stored under “measure application required/not required”. Note that a reason for application of measures not being required may be stored as measure application information.

If it is determined that there is no dependency relation between the library corresponding to the vulnerability program and another library, the output information generation unit 15 generates output information indicating that a version upgrade of the library corresponding to the vulnerability program can be performed, with respect to the version of the program.

In addition, if it is determined that there is a dependency relation between the library corresponding to the vulnerability program and another library, the output information generation unit 15 generates output information indicating that a version upgrade of the library corresponding to the vulnerability program cannot be performed, with respect to the version of the program.

In addition, if it is determined that the setting information is changeable, the output information generation unit 15 generates output information indicating that the setting information is changeable, with respect to the version of the program. In addition, if it is determined that the setting information is unchangeable, the output information generation unit 15 generates output information indicating that the setting information is unchangeable, with respect to the version of the program.

In addition, if it is determined that a security requirement has been applied to vulnerability content information, the output information generation unit 15 generates output information indicating that the security requirement has been applied, with respect to the version of the program. In addition, if it is determined that a security requirement has not been applied to vulnerability content information, the output information generation unit 15 generates output information indicating that the security requirement has not been applied, with respect to the version of the program.

Specifically, the output information generation unit 15 generates output information for outputting the determination result information 29 shown in FIG. 7, and transmits the generated output information to the terminal apparatus 30.

### Apparatus Operations

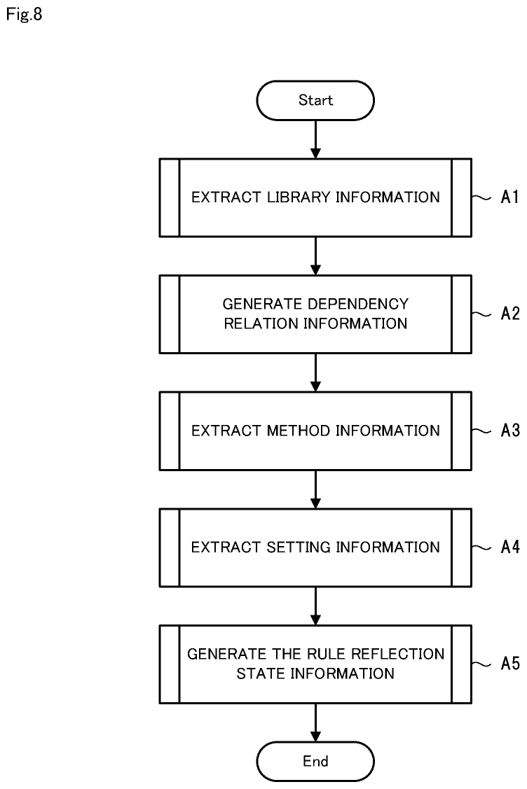

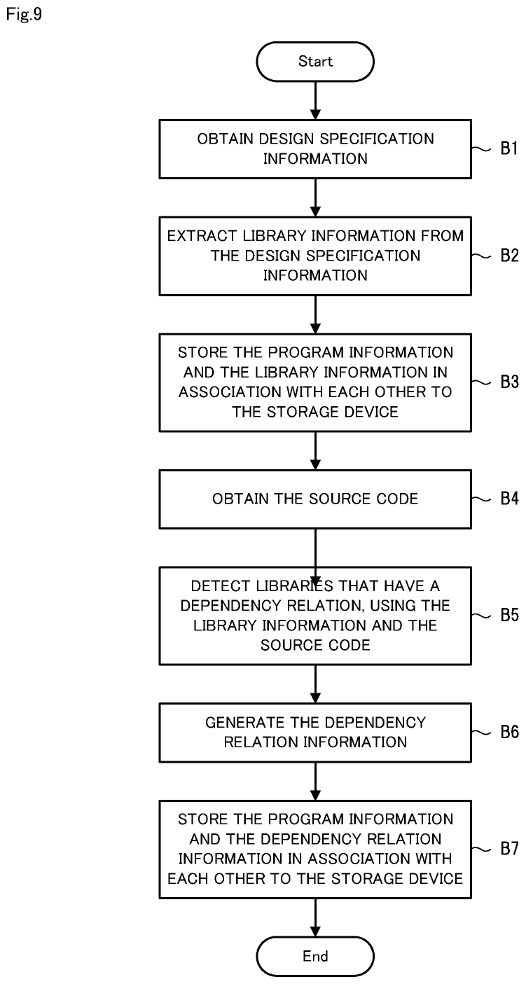

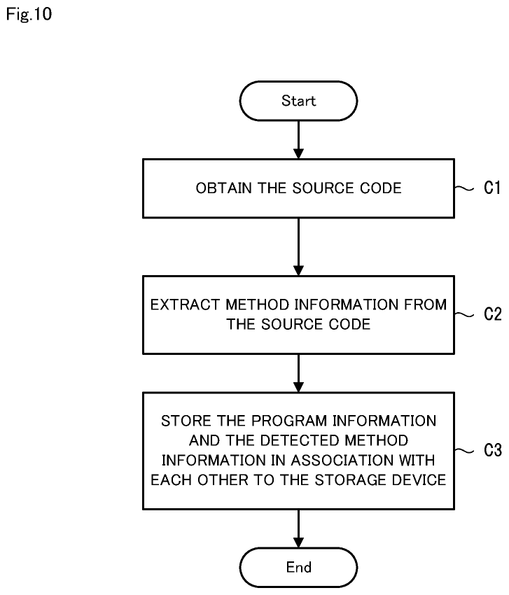

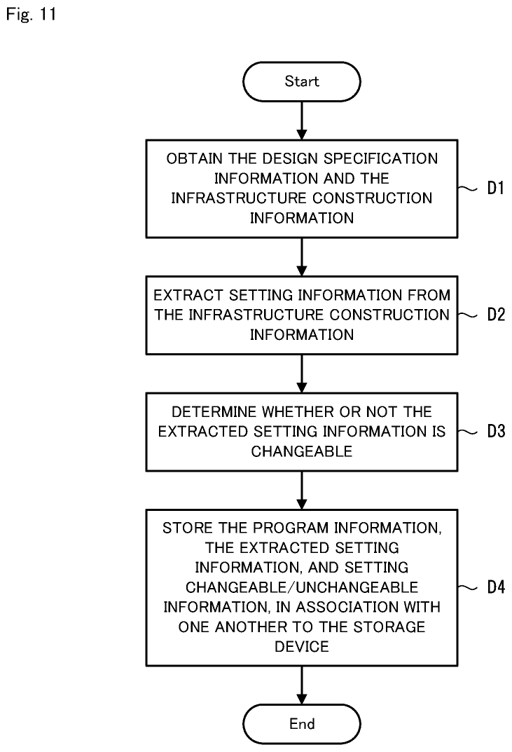

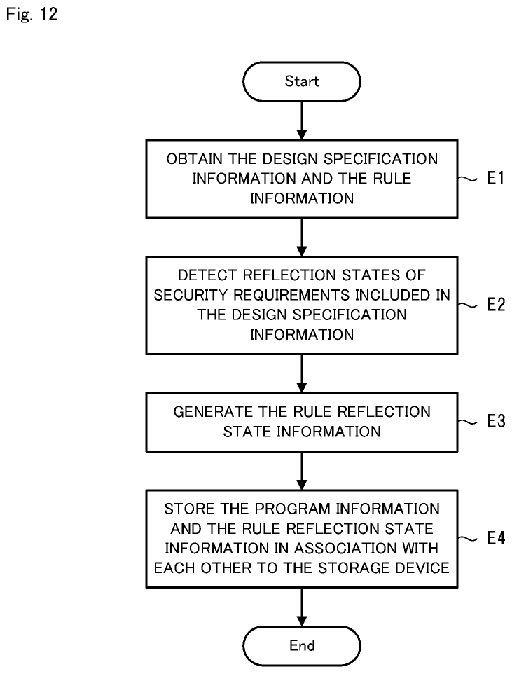

Next, operations of the information processing apparatus (the extraction unit and the generation unit) according to the example embodiment will be described with reference to FIGS. 8, 9, 10, 11, and 12. FIG. 8 is a diagram for describing operation examples of the information processing apparatus (the extraction unit and the generation unit). FIG. 9 is a diagram for describing operation examples of steps A1 and A2. FIG. 10 is a diagram for describing an operation example of step A3. FIG. 11 is a diagram for describing an operation example of step A4. FIG. 12 is a diagram for describing an operation example of step A5.

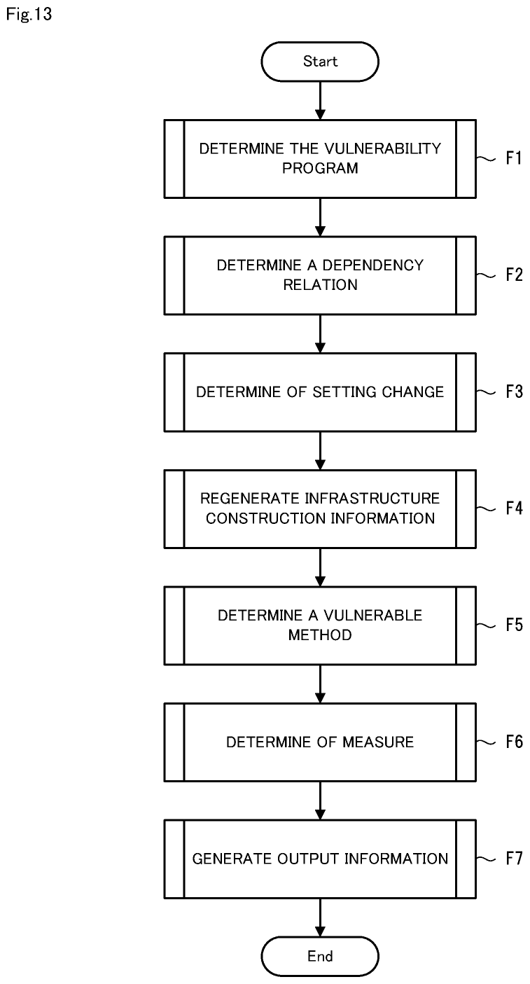

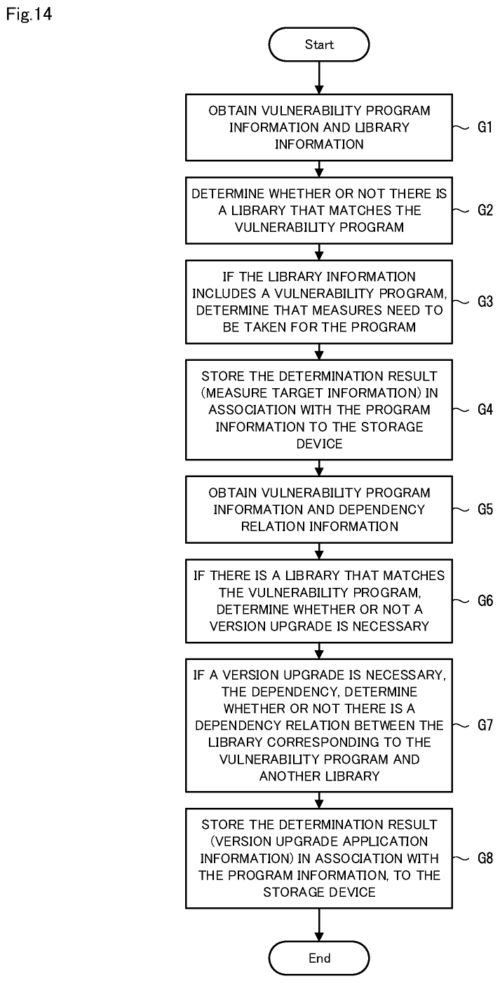

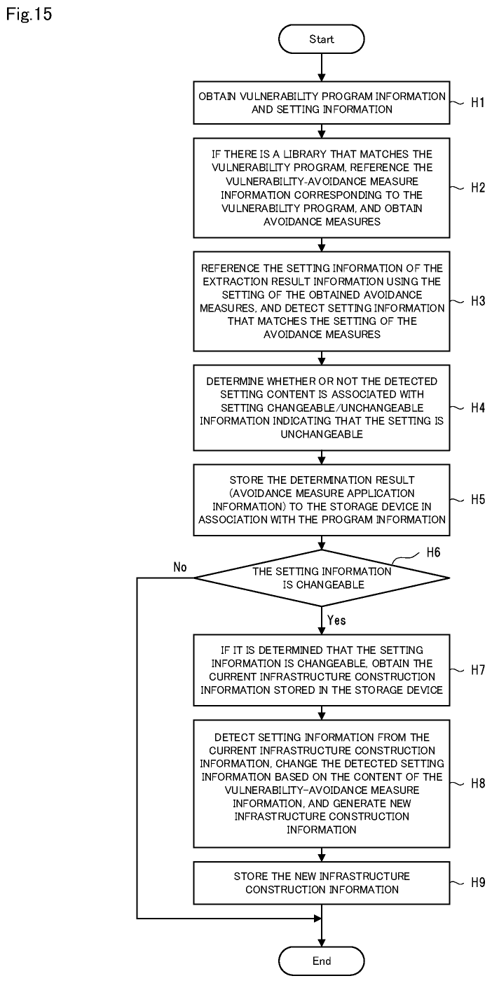

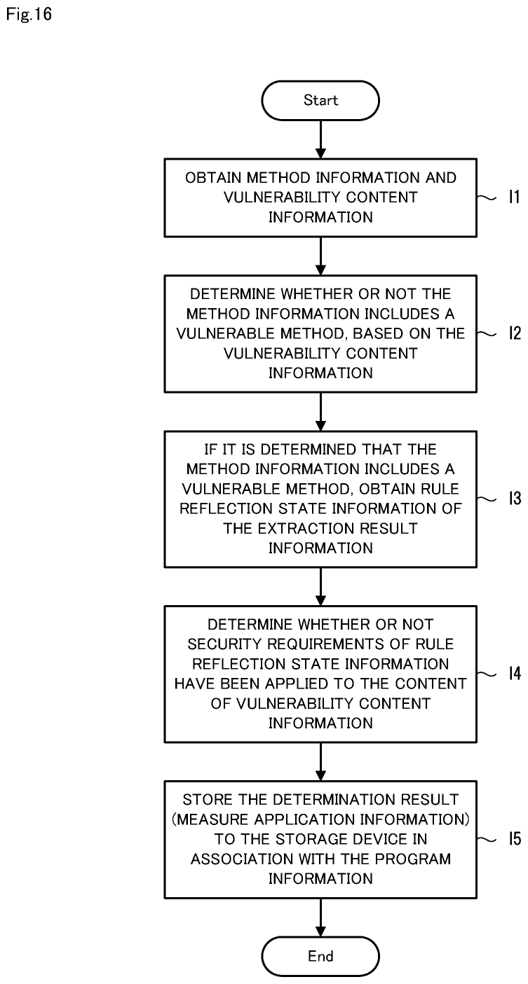

In addition, operations of the information processing apparatus (the determination unit, the infrastructure construction information regeneration unit, and the output information generation unit) according to the example embodiment will be described with reference to FIGS. 13, 14, 15, and 16. FIG. 13 is a diagram for describing operation examples of the information processing apparatus (the determination unit, the infrastructure construction information regeneration unit, and the output information generation unit). FIG. 14 is a diagram for describing operation examples of steps F1 and F2. FIG. 15 is a diagram for describing operation examples of steps F3 and F4. FIG. 16 is a diagram for describing operation examples in steps F5 and F6.

In the following description, figures are referenced as appropriate. In addition, in an example embodiment, an information processing method is performed by causing the information processing apparatus to operate. Thus, a description of the information processing method according to the example embodiment is replaced with the following description of the operations of the information processing apparatus.

Operations of the extraction unit 11 and the generation unit 12 will be described.

As shown in FIG. 8, first, the library information extraction unit 111 of the extraction unit 11 extracts library information indicating one or more libraries included in the design specification information 21 indicating the design specification of a program that is used in a target system (step A1). Step A1 will be described later in detail with reference to FIG. 9.

Next, the dependency relation information generation unit 121 of the generation unit 12 generates the dependency relation information 25 indicating the dependency relation between libraries based on the library information and the source code 22 (step A2). Step A2 will be described later in detail with reference to FIG. 9.

Next, the method information extraction unit 112 of the extraction unit 11 extracts method information indicating one or more methods included in the source code 22 of the program (step A3). Step A3 will be described later in detail with reference to FIG. 10.

Next, the setting information extraction unit 113 of the extraction unit 11 extracts setting information indicating one or more setting contents that are used in an infrastructure that is indicated by the infrastructure construction information 23 and is for constructing the system (step A4). Step A4 will be described later in detail with reference to FIG. 11.

Next, the rule reflection state information generation unit 122 of the generation unit 12 uses the rule information 26 indicating security requirements of the system, to detect reflection states of security requirements included in the design specification information 21, and generates the rule reflection state information 27 indicating the reflection states of the respective security requirements (step A5). Step A5 will be described later in detail with reference to FIG. 12.

The processing of steps A1 and A2 will be described.

As shown in FIG. 9, in step A1, first, the library information extraction unit 111 obtains the design specification information 21 stored in the storage device 20 (step B1). Next, the library information extraction unit 111 extracts library information from the design specification information 21 (library extracting processing) (step B2). Next, the library information extraction unit 111 stores program information indicating a program that is used in a target system and the extracted library information in association with each other to the storage device 20 (step B3).

Next, as shown in FIG. 9, in step A2, the dependency relation information generation unit 121 obtains the library information and the source code 22 stored in the storage device 20 (step B4). Next, the dependency relation information generation unit 121 detects libraries that have a dependency relation, using the library information and the source code (library dependency relation detection processing) (step B5). Next, the dependency relation information generation unit 121 generates the dependency relation information 25 indicating the dependency relation between the libraries (step B6). Next, the dependency relation information generation unit 121 stores the program information and the dependency relation information in association with each other to the storage device 20 (step B7).

The above processing of steps A1 (B1 to B3) and A2 (B4 to B7) is repeatedly executed for each version of the program.

The processing of step A3 will be described.

As shown in FIG. 10, in step A3, first, the method information extraction unit 112 obtains the source code 22 stored in the storage device 20 (step C1). Next, the method information extraction unit 112 extracts method information from the source code 22 (method extracting processing) (step C2). Next, the method information extraction unit 112 stores the program information indicating the program that is used in the target system and the detected method information in association with each other to the storage device 20 (step C3).

The above processing of step A3 (C1 to C3) is repeatedly executed for each version of the program.

The processing of step A4 will be described.

As shown in FIG. 11, in step A4, first, the setting information extraction unit 113 obtains the design specification information 21 and the infrastructure construction information 23 stored in the storage device 20 (step D1). Next, the setting information extraction unit 113 extracts setting information from the infrastructure construction information 23 (setting information extracting processing) (step D2). Next, the setting information extraction unit 113 searches for the extracted setting information in the design specification information 21, and determines whether or not the extracted setting information is changeable (step D3). Next, the setting information extraction unit 113 stores the program information indicating the program that is used in the target system, the extracted setting information, and setting changeable/unchangeable information indicating whether or not the setting information is changeable, in association with one another to the storage device 20 (step D4).

The above processing of step A4 (D1 to D3) is repeatedly executed for each version of the program.

The processing of step A5 will be described.

As shown in FIG. 12, in step A5, first, the rule reflection state information generation unit 122 obtains the design specification information 21 and the rule information 26 stored in the storage device 20 (step E1). Next, the rule reflection state information generation unit 122 detects reflection states of security requirements included in the design specification information 21 using the design specification information 21 and the rule information 26 (rule reflection state detection processing) (step E2). Next, the rule reflection state information generation unit 122 generates the rule reflection state information 27 indicating the reflection states of the respective security requirements (step E3). Next, the rule reflection state information generation unit 122 stores the program information and the rule reflection state information 27 in association with each other to the storage device 20 (step E4).

The above processing of step A5 (E1 to E4) is repeatedly executed for each version of the program.

As described above, the extraction result information 24, the dependency relation information 25, and the rule reflection state information 27 such as those shown in FIGS. 2, 3, and 5 are generated. Note that the extraction result information 24 may include the dependency relation information 25 and the rule reflection state information 27.

Operations of the determination unit 13 and the infrastructure construction information regeneration unit 14 will be described.

As shown in FIG. 13, first, the vulnerability program determination unit 131 determines whether or not the library information includes a vulnerability program indicating a program that has a vulnerability (step F1). Step F1 will be described later in detail with reference to FIG. 14.

Next, if the library information includes a vulnerability program, and a version upgrade of the vulnerability program is necessary, the dependency relation determination unit 132 determines whether or not there is a dependency relation between the library corresponding to the vulnerability program and another library, based on the dependency relation information (step F2). Step F2 will be described later in detail with reference to FIG. 14.

Next, the setting change determination unit 133 determines whether or not setting information is changeable, based on vulnerability-avoidance measure information that indicates a content for avoiding the vulnerability and corresponds to the vulnerability program (step F3). Step F3 will be described later in detail with reference to FIG. 15.

Next, the infrastructure construction information regeneration unit 14 changes the setting information of the current infrastructure construction information based on the vulnerability-avoidance measure information if it is determined that the setting information is changeable, and generates new infrastructure construction information (step F4). Step F4 will be described later in detail with reference to FIG. 15.

Next, the vulnerable method determination unit 134 determines whether or not method information includes a vulnerable method, based on vulnerability content information indicating the content of the vulnerability and corresponding to the vulnerability program (step F5). Step F5 will be described later in detail with reference to FIG. 16.

Next, the measure determination unit 135 determines whether or not security requirements of rule reflection state information have been applied to the content of the vulnerability indicated by the vulnerability content information (step F6). Step F6 will be described later in detail with reference to FIG. 16.

Next, the output information generation unit 15 converts the design specification information 21, the source code 22, the infrastructure construction information 23, the extraction result information 24, the dependency relation information 25, the rule information 26, the rule reflection state information 27, the vulnerability information 28, the determination result information 29, and the like, into a format that can be output, and generates output information (step F7). The terminal apparatus 30 then outputs a generated image, sound, and the like based on the output information. Note that step F7 will be described later in detail.

The processing of step F1 will be described.

As shown in FIG. 14, in step F1, first, the vulnerability program determination unit 131 obtains vulnerability program information of the vulnerability information 28, and library information of the extraction result information 24, which are stored in the storage device 20 (step G1). Next, the vulnerability program determination unit 131 references the library information using the vulnerability program information, and determines whether or not there is a library that matches the vulnerability program (step G2).

Next, if the library information includes a vulnerability program (a library that has a vulnerability), the vulnerability needs to be handled in the program that is used in the target system, and thus the vulnerability program determination unit 131 determines that measures need to be taken for the program (step G3). Next, the vulnerability program determination unit 131 stores the determination result (measure target information) in association with the program information to the storage device 20 (step G4).

The processing of step F2 will be described.

As shown in FIG. 14, in step F2, first, the dependency relation determination unit 132 obtains vulnerability program information of the vulnerability information 28 stored in the storage device 20 and dependency relation information (step G5). Next, if there is a library that matches the vulnerability program, the dependency relation determination unit 132 references vulnerability version upgrade information corresponding to the vulnerability program, and determines whether or not a version upgrade is necessary (step G6).

Next, if a version upgrade is necessary, the dependency relation determination unit 132 references dependency relation information, and determines whether or not there is a dependency relation between the library corresponding to the vulnerability program and another library (step G7).

Next, the dependency relation determination unit 132 stores the determination result (version upgrade application information) in association with the program information, to the storage device 20 (step G8).

The processing of step F3 will be described.

As shown in FIG. 15, in step F3, first, the setting change determination unit 133 obtains vulnerability program information of the vulnerability information 28 stored in the storage device 20 and setting information of the extraction result information 24 (step H1). Next, if there is a library that matches the vulnerability program, the setting change determination unit 133 references the vulnerability-avoidance measure information corresponding to the vulnerability program, and obtains avoidance measures (step H2).

Next, the setting change determination unit 133 references the setting information of the extraction result information 24 using the setting (set value) of the obtained avoidance measures, and detects setting information “setting content” that matches the setting of the avoidance measures (step H3). Next, if the detected setting content is associated with setting changeable/unchangeable information indicating that the setting is unchangeable, the setting change determination unit 133 determines that the setting information cannot be changed to the setting (set value) of the avoidance measures (step H4). In contrast, if the detected setting content is not associated with setting changeable/unchangeable information indicating that the setting is unchangeable, the setting change determination unit 133 determines that the setting information can be changed to the setting (set value) of the avoidance measures (step H4).

Next, the setting change determination unit 133 stores the determination result (avoidance measure application information) to the storage device 20 in association with the program information (step H5).

The processing of step F4 will be described.

As shown in FIG. 15, in step F4, if it is determined that the setting information is changeable (step H6: Yes), the infrastructure construction information regeneration unit 14 first obtains the current infrastructure construction information stored in the storage device 20 (step H7). Next, the infrastructure construction information regeneration unit 14 detects setting information from the current infrastructure construction information, changes the detected setting information based on the content of the vulnerability-avoidance measure information, and generates new infrastructure construction information (step H8). Next, the infrastructure construction information regeneration unit 14 stores the new infrastructure construction information to the storage device 20 (step H9). In contrast, if it is determined that the setting information is unchangeable (step H6: No), the infrastructure construction information regeneration unit 14 advances the procedure to the processing of step F5.

The processing of step F5 will be described.

As shown in FIG. 16, in step F5, first, the vulnerable method determination unit 134 obtains method information of the extraction result information 24 and vulnerability content information of the vulnerability information 28, which are stored in the storage device 20 (step I1).

Next, the vulnerable method determination unit 134 determines whether or not the method information includes a vulnerable method, based on the vulnerability content information (step I2).

The processing of step F6 will be described.

As shown in FIG. 16, in step F6, first, if it is determined that the method information includes a vulnerable method, the measure determination unit 135 obtains rule reflection state information of the extraction result information 24 stored in the storage device 20 (step I3). Next, the measure determination unit 135 determines whether or not security requirements of rule reflection state information have been applied to the content of vulnerability content information (step I4). Next, the measure determination unit 135 stores the determination result (measure application information) to the storage device 20 in association with the program information (step I5).

The processing of step F7 will be described.

In step F7, for example, if it is determined that there is no dependency relation between the library corresponding to the vulnerability program and another library, the output information generation unit 15 generates output information indicating a version upgrade of the library corresponding to the vulnerability program can be performed, with respect to the version of the program.

In addition, if it is determined that there is a dependency relation between the library corresponding to the vulnerability program and another library, the output information generation unit 15 generates output information indicating that a version upgrade of the library corresponding to the vulnerability program cannot be performed, with respect to the version of the program.

In addition, if it is determined that the setting information is changeable, the output information generation unit 15 generates output information indicating that the setting information is changeable, with respect to the version of the program. In addition, if it is determined that the setting information is unchangeable, the output information generation unit 15 generates output information indicating that the setting information is unchangeable, with respect to the version of the program.

In addition, if it is determined that the security requirement has been applied to the vulnerability content information, the output information generation unit 15 generates output information indicating that the security requirements have been applied, with respect to the version of the program. In addition, if it is determined that the security requirement has not been applied to the vulnerability content information, the output information generation unit 15 generates output information indicating that the security requirement has not been applied, with respect to the version of the program.

Subsequently, the output information generation unit 15 generates output information for outputting the determination result information 29 shown in FIG. 7, and transmits the generated output information to the terminal apparatus 30.

### Effects of Example Embodiment

Aversion upgrade (for example, applying a patch) cannot be executed every time a system that is constantly operating is notified of a vulnerability, and thus a state where there is the possibility that the system will be exposed to threats will continue.

For this reason, the operator or developer of the system desires to investigate the influence on the system, and put off a version upgrade for handling a vulnerability that does not affect the system, but the investigation of the influence on the system requires expertise. Furthermore, investigation needs to be performed on the source code and design specification, and thus the investigation requires a long time.

However, according to the example embodiment, when notification of a vulnerability is performed, it is possible to generate determination result information (measure target information, version upgrade application information, avoidance measure application information, and measure application information), and present a method for handling the vulnerability, for each version of the program for providing a product or a service. For this reason, it is possible to present how the operator or developer of the system should handle the vulnerability. In this manner, when notification of a vulnerability is performed, it is possible to determine whether or not the system will be affected, and to render assistance, and thus the investigation time can be reduced, and the safety of the system can be improved.

In addition, conventionally, POC (Proof of Concept) is executed to confirm whether or not an actual attack will be successful, or determination is manually performed as to whether or not the influence from abuse of a vulnerability (impact) has been mitigated, based on the knowledge of an operator (manager or developer). In the case of a vulnerability that causes an external malicious script to be executed, for example, the operator needs to know that “no problem will occur if access to the outside is restricted”. However, according to the example embodiment, the operator can perform determination using a method that does not depend on a result of executing POC or the knowledge of the operator.

In addition, conventionally, an operator (manager or developer) has determined whether to take avoidance measures, by actually accessing an evaluation environment and performing operation check in order to check the avoidance measures. However, according to the example embodiment, determination is performed based on design specification information and infrastructure construction information (for example, IaC). Furthermore, setting information is detected from the current infrastructure construction information, the detected setting information is changed based on the content of vulnerability-avoidance measure information, and new infrastructure construction information is generated.

### [Program]

The program according to the example embodiment may be a program that causes a computer to execute steps A1 to A2 (B1 to B7), A3 (C1 to C3), A4 (D1 to D3), A5 (E1 to E4), F1 to F2 (G1 to G8), F3 to F4 (H1 to H9), F5 to F6 (I1 to I5), and F7 shown in FIG. 8. By installing this program in a computer and executing the program, the information processing apparatus and the information processing method according to the example embodiment can be realized. Further, the processor of the computer performs processing to function as the extraction unit 11 (the library information extraction unit 111, the method information extraction unit 112, and the setting information extraction unit 113), the generation unit 12 (the dependency relation information generation unit 121 and the rule reflection state information generation unit 122), the determination unit 13 (the vulnerability program determination unit 131, the dependency relation determination unit 132, the setting change determination unit 133, the vulnerable method determination unit 134, and the measure determination unit 135), the infrastructure construction information regeneration unit 14, and the output information generation unit 15.

Also, the program according to the example embodiment may be executed by a computer system constructed by a plurality of computers. In this case, for example, each computer may function as any of the extraction unit 11 (the library information extraction unit 111, the method information extraction unit 112, and the setting information extraction unit 113), the generation unit 12 (the dependency relation information generation unit 121 and the rule reflection state information generation unit 122), the determination unit 13 (the vulnerability program determination unit 131, the dependency relation determination unit 132, the setting change determination unit 133, the vulnerable method determination unit 134, and the measure determination unit 135), the infrastructure construction information regeneration unit 14, and the output information generation unit 15.

### [Physical Configuration]

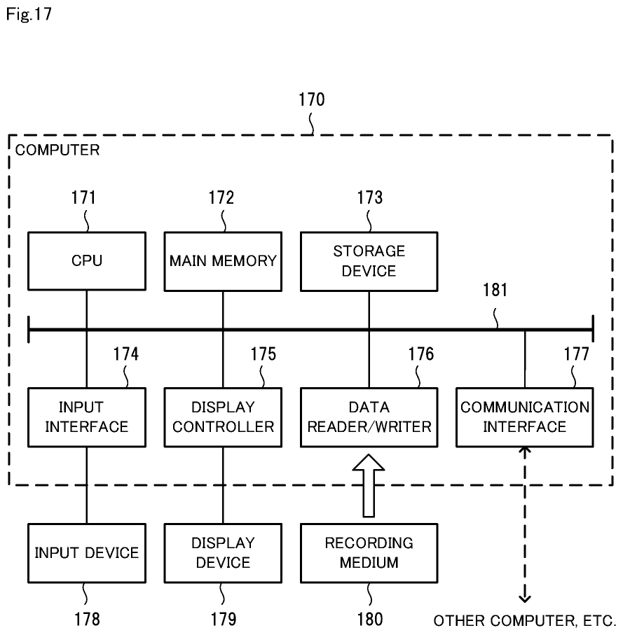

Here, a computer that realizes an information processing apparatus by executing the program according to the example embodiment will be described with reference to FIG. 17. FIG. 10 is a block diagram showing an example of a computer that realizes the search support apparatus according to an example embodiment of the present invention.

As shown in FIG. 17, a computer 170 includes a CPU (Central Processing Unit) 171, a main memory 172, a storage device 173, an input interface 174, a display controller 175, a data reader/writer 176, and a communications interface 177. These units are each connected so as to be capable of performing data communications with each other through a bus 181. Note that the computer 170 may include a GPU (Graphics Processing Unit) or an FPGA (Field-Programmable Gate Array) in addition to the CPU 171 or in place of the CPU 171.

The CPU 171 opens the program (code) according to this example embodiment, which has been stored in the storage device 173, in the main memory 172 and performs various operations by executing the program in a predetermined order. The main memory 172 is typically a volatile storage device such as a DRAM (Dynamic Random Access Memory). Also, the program according to this example embodiment is provided in a state being stored in a computer-readable recording medium 180. Note that the program according to this example embodiment may be distributed on the Internet, which is connected through the communications interface 117.

Also, other than a hard disk drive, a semiconductor storage device such as a flash memory can be given as a specific example of the storage device 173. The input interface 174 mediates data transmission between the CPU 171 and an input device 178, which may be a keyboard or mouse. The display controller 175 is connected to a display device 179, and controls display on the display device 179.

The data reader/writer 176 mediates data transmission between the CPU 171 and the recording medium 180, and executes reading of a program from the recording medium 180 and writing of processing results in the computer 170 to the recording medium 180. The communications interface 177 mediates data transmission between the CPU 171 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 180.

Also, instead of a computer in which a program is installed, the information processing apparatus 10 according to this example embodiment can also be realized by using hardware corresponding to each unit. Furthermore, a portion of the information processing apparatus 10 may be realized by a program, and the remaining portion realized by hardware.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

As described above, according to the present invention, a method for handling a vulnerability can be presented It is also useful in fields where attack analysis is required.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. An information processing apparatus comprising:
a library information extraction unit that extracts library information indicating one or more libraries included in design specification information indicating a design specification of a program that is used in a target system;
a dependency relation information generation unit that generates dependency relation information indicating a dependency relation between the libraries, based on the library information and a source code of the program;
a vulnerability program determination unit that determines whether or not the library information includes a vulnerability program indicating a program that has a vulnerability;
a dependency relation determination unit that, if the library information includes the vulnerability program and a version upgrade of the vulnerability program is necessary, determining whether or not there is a dependency relation between a library corresponding to the vulnerability program and another library, based on the dependency relation information; and
an output information generation unit that, if it is determined that there is no dependency relation between the library corresponding to the vulnerability program and another library, generating output information indicating that it is possible to perform a version upgrade of the library corresponding to the vulnerability program, with respect to a version of the program.

2. The information processing apparatus according to claim 1,
wherein, if it is determined that there is a dependency relation between the library corresponding to the vulnerability program and another library, the output information generation unit generates output information indicating that it is not possible to perform a version upgrade of the library corresponding to the vulnerability program, with respect to the version of the program.

3. The information processing apparatus according to claim 1, further comprising:
a setting information extraction unit that extracts setting information indicating one or more setting contents that are used in an infrastructure that is indicated by infrastructure construction information and is for constructing the system; and
a setting change determination unit that determines whether or not the setting information is changeable, based on vulnerability-avoidance measure information that indicates a content for avoiding a vulnerability and corresponds to the vulnerability program,
wherein, if it is determined that the setting information is changeable, the output information generation unit generates output information indicating that the setting information is changeable, with respect to the version of the program.

4. The information processing apparatus according to claim 3,
wherein, if it is determined that the setting information is not changeable, the output information generation unit generates output information indicating that the setting information is not changeable, with respect to the version of the program.

5. The information processing apparatus according to claim 4, further comprising:
an infrastructure construction information regeneration unit that, if it is determined that the setting information is changeable, changing the setting information of current infrastructure construction information based on the vulnerability-avoidance measure information, and generating new infrastructure construction information.

6. The information processing apparatus according to claim 1, further comprising:
a method information extraction unit that extracts method information indicating one or more methods included in the source code; and
a vulnerable method determination unit that determines whether or not the method information includes a vulnerable method, based on vulnerability content information indicating a content of a vulnerability and corresponding to the vulnerability program.

7. The information processing apparatus according to claim 6, further comprising:
a rule reflection state information generation unit that detects a reflection state of a security requirement of the system included in the design specification information, using rule information indicating the security requirement, and generating rule reflection state information indicating the reflection state for each security requirement; and
a measure determination unit that determines whether or not the security requirement of the rule reflection state information has been applied to a content of the vulnerability indicated by the vulnerability content information,
wherein, if it is determined that the security requirement has been applied to the vulnerability content information, the output information generation unit generates output information indicating that the security requirement has been applied, with respect to the version of the program.

8. The information processing apparatus according to claim 7,
wherein, if it is determined that the security requirement has not been applied to the vulnerability content information, the output information generation unit generates output information indicating that the security requirement has not been applied, with respect to the version of the program.

9. An information processing method including instructions that cause an information processing apparatus to carry out:
extracting library information indicating one or more libraries included in design specification information indicating a design specification of a program that is used in a target system;
generating dependency relation information indicating a dependency relation between the libraries, based on the library information and a source code of the program;
determining whether or not the library information includes a vulnerability program indicating a program that has a vulnerability;
if the library information includes the vulnerability program and a version upgrade of the vulnerability program is necessary, determining whether or not there is a dependency relation between a library corresponding to the vulnerability program and another library, based on the dependency relation information; and
if it is determined that there is no dependency relation between the library corresponding to the vulnerability program and another library, generating output information indicating that it is possible to perform a version upgrade of the library corresponding to the vulnerability program, with respect to a version of the program.

10. A non-transitory computer-readable recording medium including a program recorded on the computer-readable recording medium, the program including instructions that cause the computer to carry out:
extracting library information indicating one or more libraries included in design specification information indicating a design specification of a program that is used in a target system;
generating dependency relation information indicating a dependency relation between the libraries, based on the library information and a source code of the program;
determining whether or not the library information includes a vulnerability program indicating a program that has a vulnerability;
if the library information includes the vulnerability program and a version upgrade of the vulnerability program is necessary, determining whether or not there is a dependency relation between a library corresponding to the vulnerability program and another library, based on the dependency relation information; and
if it is determined that there is no dependency relation between the library corresponding to the vulnerability program and another library, generating output information indicating that it is possible to perform a version upgrade of the library corresponding to the vulnerability program, with respect to a version of the program.
